(19) United States
(12) Patent Application Publication
(10) Pub. No.: US 2024/0083353 A1
(43) Pub. Date: Mar. 14, 2024

(54) Container Misalignment Detection System and Methods for Autonomous Vehicles

(71) Applicant: Venti Technologies, Singapore (SG)

(72) Inventors: Sun XIN, Singapore (SG); Mahdi ABOLFAZLI ESFAHANI, Singapore (SG); Xinxin DU, Singapore (SG)

(21) Appl. No.: 18/452,635

(22) Filed: Aug. 21, 2023

(30) Foreign Application Priority Data
Sep. 14, 2022 (SG) 10202250994X

(51) Int. Cl. B60Q 9/00; B60P 1/54; G01S 17/89

(52) U.S. Cl. CPC B60Q 9/00; B60P 1/54; G01S 17/89

(57) ABSTRACT

Systems, methods, and computer program products are described herein for container misalignment detection for an autonomous vehicle. Misalignment of a container loaded onto an autonomous vehicle is detected by receiving data including an indication that the container is loaded onto the autonomous vehicle. A scanning device mounted on the autonomous vehicle captures a plurality of data points in the vicinity of the container. A misalignment detection module identifies a first data point of the plurality of data points and a second data point of the plurality of data points. The misalignment detection module evaluates a height difference between a height of the first data point and a height of the second data point. The misalignment detection module determines whether the container is misaligned on the autonomous vehicle based on the height difference. An indication of whether the container is misaligned is provided.

### CROSS-REFERENCE TO RELATED APPLICATION

The present application claims priority to Singapore Application No. 10202250994X, filed Sep. 14, 2022, the contents of which is incorporated by reference herein in its entirety.

### TECHNICAL FIELD

The subject matter described herein relates to container misalignment detection systems for autonomous vehicles.

### BACKGROUND

Automation is the use of computing systems to accomplish various tasks without the need of human intervention. Various industries utilize automation to complete tasks, for example, to reduce costs and/or improve efficiency. Example industries that use such automation include the automotive industry and shipping industry.

### BRIEF DESCRIPTION OF THE DRAWINGS

Aspects of the present disclosure are best understood from the following detailed description when read with the accompanying figures:

FIG. 1A is a block diagram illustrating a rear view of an autonomous vehicle with a container that is misaligned in accordance with various embodiments of the present disclosure.

FIG. 1B is a block diagram 150 illustrating a rear view of an autonomous vehicle with a container that is properly aligned in accordance with various embodiments of the present disclosure.

FIG. 2A is a diagram illustrating a side view of an example autonomous vehicle for transporting containers in accordance with various embodiments of the present disclosure.

FIG. 2B is a diagram illustrating a top view of an example autonomous vehicle for transporting containers in accordance with various embodiments of the present disclosure.

FIG. 3 is a diagram illustrating a side view of an example APM head in accordance with various embodiments of the present disclosure.

FIG. 4 is a diagram illustrating a top view of multiple LiDAR scanning zones that cumulatively form a 360-degree LiDAR scanning zone of an example autonomous vehicle in accordance with various embodiments of the present disclosure.

FIG. 5 is a process flow diagram illustrating a method of detecting container misalignment on an autonomous vehicle in accordance with various embodiments of the present disclosure.

FIG. 6 is a process flow diagram illustrating additional steps performed by the misalignment detection module of autonomous vehicle in accordance with various embodiments of the present disclosure.

FIG. 7 is a process flow diagram illustrating a method for detecting misalignment of a container loaded onto an autonomous vehicle in accordance with various embodiments of the present disclosure.

FIG. 8 illustrates an example container misalignment detection system that processes input data and generates output data in accordance with various embodiments of the present disclosure.

FIG. 9 is a diagram illustrating a sample computing device architecture for implementing various aspects described herein in which certain components can be omitted depending on the application.

### SUMMARY

In one aspect, a method for detecting misalignment of a container loaded onto an autonomous vehicle includes receiving data having an indication that the container is loaded onto the autonomous vehicle. A scanning device mounted on the autonomous vehicle captures a plurality of data points in the vicinity of the container. A misalignment detection module identifies a first data point of the plurality of data points and a second data point of the plurality of data points. The misalignment detection module determines whether the container is misaligned on the autonomous vehicle based on a height difference between a height of the first data point and a height of the second data point. An indication of whether the container is misaligned is provided.

In some variations, the container can be misaligned when the height difference is greater than a height difference threshold.

In other variations, the first data point can be located on a top front left corner of the container and the second data point is located on a top front right corner of the container.

In some variations, the method can further comprise identifying, using a misalignment detection module, heights associated with each of the plurality of data points, and identifying a maximum height of the plurality of data points that defines a rooftop of the container. The first data point and the second data point can be identified from a subset of the plurality of datapoints located within a designated three-dimensional region surrounding the based on a height that is greater than the maximum height minus an error correction value.

In other variations, the plurality of data points can include a plurality of light and detection ranging (LiDAR) data points.

In some variations, the autonomous vehicle can include a head and a trailer for loading of the container, and the scanning device can be a light and detection ranging (LiDAR) scanning device mounted on a center line of the head. The LiDAR scanning device can be mounted perpendicular to a top of the head of the autonomous vehicle.

In other variations, the autonomous vehicle can be an autonomous prime mover.

In some variations, the container can be automatically loaded or unloaded onto the autonomous vehicle without manual intervention by a gantry crane, and the indication can be provided by either the gantry crane or user input.

In other variations, when the container is misaligned, an alarm can be triggered to facilitate human-aided manual re-loading or unloading of a container onto the autonomous vehicle.

Non-transitory computer program products (i.e., physically embodied computer program products) are also described that store instructions, which when executed by one or more data processors of one or more computing systems, cause at least one data processor to perform operations herein. Similarly, computer systems are also described that may include one or more data processors and memory coupled to one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the examples.

### DETAILED DESCRIPTION

Autonomous vehicles operate with minimal to no human interaction. There are numerous ways autonomous vehicles are utilized in both personal and commercial settings. In a personal setting, for example, people can use autonomous vehicles to get from point A to point B such as driving to or from work or school. In a commercial setting, autonomous vehicles can be used to transport people or goods from point A to point B such as placing goods onto or retrieving goods off of stock shelves in retail spaces or storage warehouses or moving shipping containers around in a shipping port. When autonomous vehicles are used to transport containers with goods, it is important to ensure that the containers are secured properly for transit. Lack of properly secured containers could cause damage to the containers and/or goods. It could also cause damage to the autonomous vehicle itself or the surroundings of the autonomous vehicle. A container that is not properly secured onto an autonomous vehicle is referred to as container misalignment (or a misaligned container). The systems and methods described herein can be used for detecting container misalignment of an autonomous vehicle.

The precision described herein may not be attainable by humans due to lack of visibility and positional feedback of human eyes. Additionally, it may be dangerous for a human to be close enough to a container to determine whether it is misaligned.

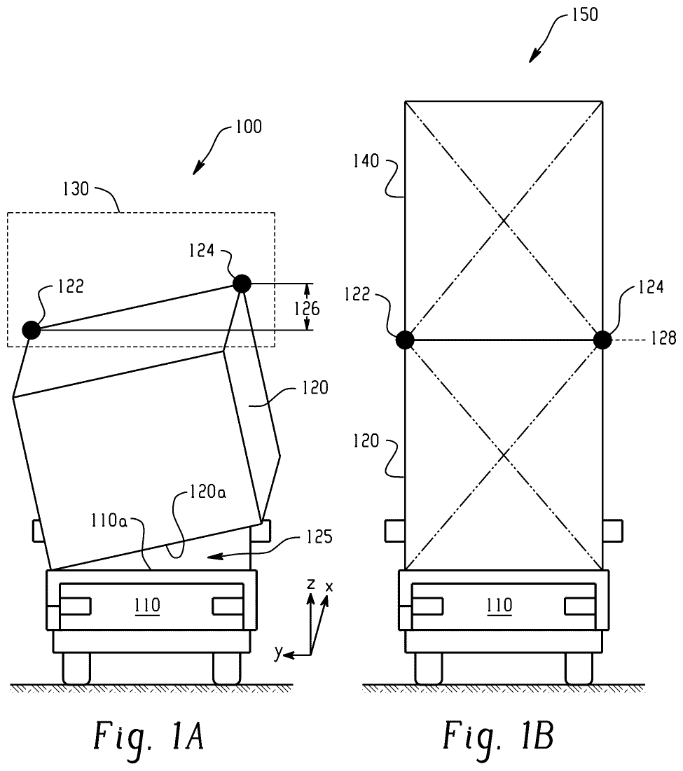

FIG. 1A is a block diagram 100 illustrating a rear view of an autonomous vehicle 110 with a container 120 that is misaligned in accordance with various embodiments of the present disclosure. The container 120 has a bottom surface 120a that is elevated off of a trailer surface 110a of autonomous vehicle 110. This elevation creates an empty space 125 between the bottom surface 120a of the container 120 and the trailer surface 110a of the autonomous vehicle. The container illustrated in FIG. 1A is not properly secured and could fall off of autonomous vehicle 110 causing damage to any goods within the container 120, the container 120 itself, the autonomous vehicle 110, and/or surroundings of the autonomous vehicle 110.

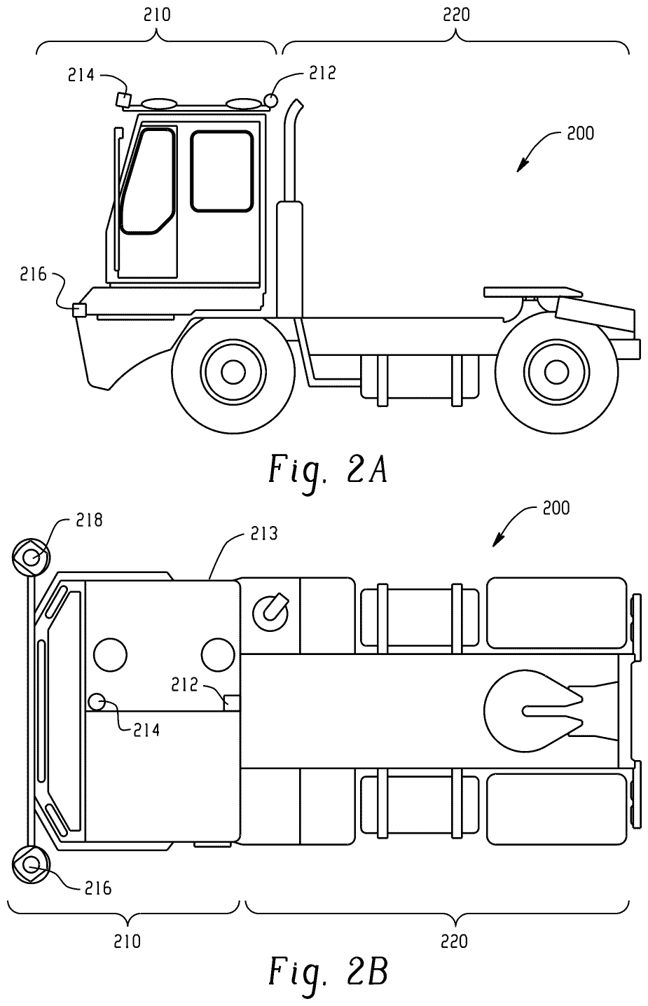

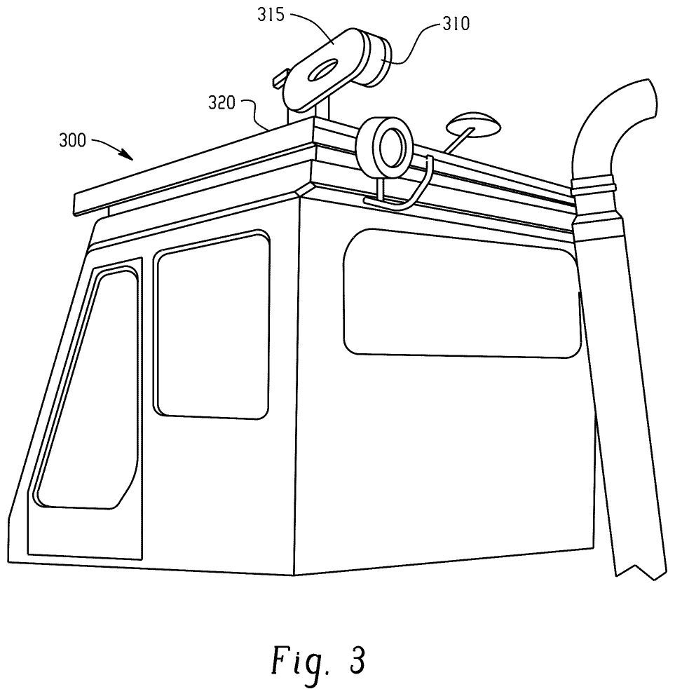

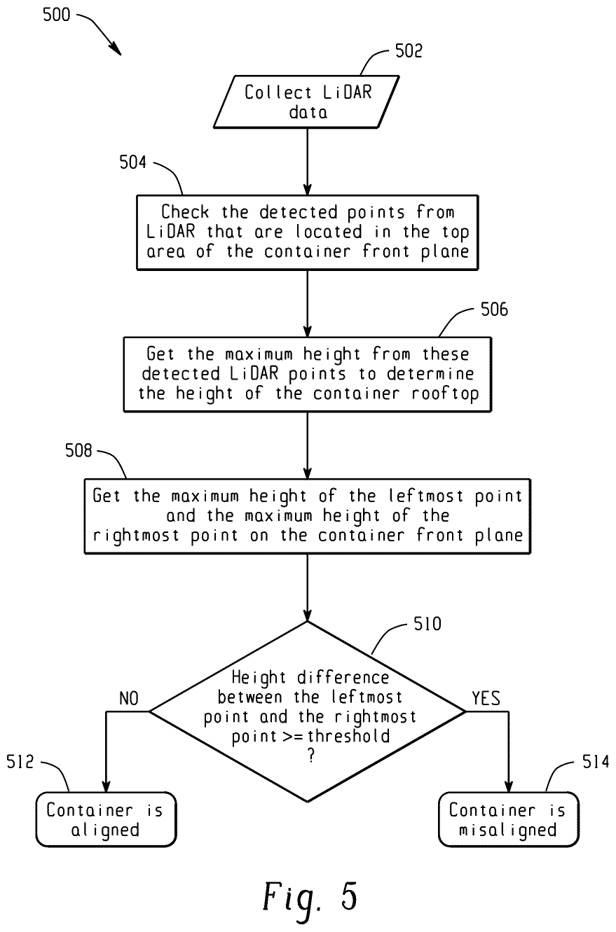

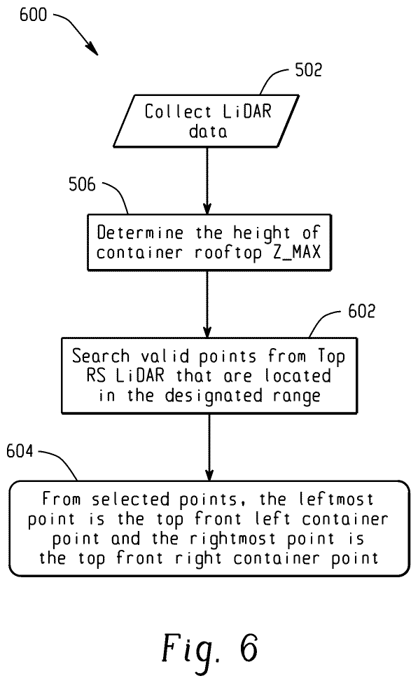

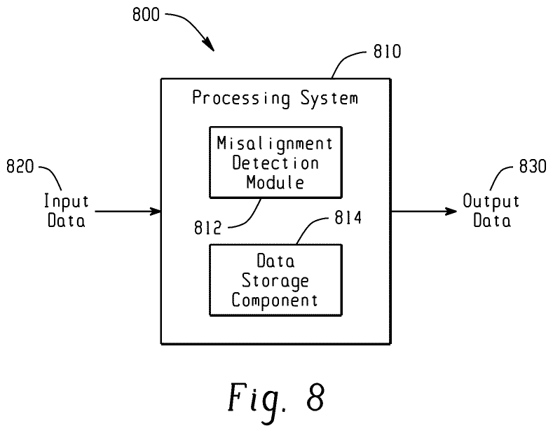

In order to detect the misalignment of container 120, the container misalignment detection system 800 described in FIG. 8 detects misalignment using container alignment points 122, 124, which is described in more detail in FIGS. 5-6. The container misalignment points 122, 124 can be located positionally on the top front left corner of the container 120 and the top front right corner of the container 120, respectively, when viewing the container 120 from the rear (e.g., at the back of the autonomous vehicle 110 looking forward). In the context of the shipping industry, the container misalignment points 122, 124 are located in a designated region 130, which is described in more detail in FIG. 6. The container misalignment points 122, 124 are detected using, for example, one or more light and detection ranging (LiDAR) scanning devices mounted on the autonomous vehicle 110, as described in more detail in FIGS. 2-3. The heights of both container misalignment points 122, 124 are evaluated to determine whether the container 120 is misaligned, as shown in FIG. 1A, or properly aligned as shown in FIG. 1B. Heights of each of the container misalignment points 122, 124 are compared to determine whether a height difference 126 exceeds a height difference threshold. If the height difference exceeds the height difference threshold, the container 120 is determined to be misaligned (e.g., height difference 126 exceeds the height difference threshold). Alternatively, if the height difference is less than or equal to the height distance threshold, the container 120 is determined to be properly aligned (e.g., height difference 128 is substantially zero and is less than the height distance threshold).

FIG. 1B is a block diagram 150 illustrating a rear view of an autonomous vehicle 110 with a container 120 that is properly aligned in accordance with various embodiments of the present disclosure. As shown in FIG. 1B, a height of both container misalignment points 122, 124 is substantially equal (e.g., height difference 128 is substantially zero). When the container 120 is properly aligned, one or more additional containers 140 can be stacked on top of container 120. Additionally, the proper alignment of container 120 helps to facilitate safe transport of the container 120 when the autonomous vehicle 110 is in motion.

FIG. 2A is a diagram illustrating a side view of an example autonomous vehicle 200 for transporting containers in accordance with various embodiments of the present disclosure. FIG. 2B is a diagram illustrating a top view of the example autonomous vehicle 200 for transporting containers in accordance with various embodiments of the present disclosure. The example autonomous vehicle 200 of FIGS. 2A-2B is specific to the shipping industry. However, it can be appreciated by those of ordinary skill in the art that this is merely an example for illustrative purposes. In a shipping port such as a container transshipment hub, an example autonomous vehicle 200 is an autonomous platform mover (APM) such as an autonomous prime mover. In this example, the autonomous vehicle 200 includes an APM head 210 and an APM trailer 220. One or more containers (e.g., containers 120, 140) can be placed on APM trailer 220 for securement and transport. For the purpose of illustration and ease of understanding, no containers are illustrated in FIGS. 2A-2B. Mounting and/or offloading containers onto the APMs can be performed by an external entity such as a gantry crane (not shown).

The APM head 210 includes a cabin 213 housing electronics for operation of the autonomous vehicle 200, including the container misalignment detection system 800 described in FIG. 8. The APM head 210 can include one or more LiDAR scanning devices 212, 214, 216, 218 mounted thereon. More specifically, LiDAR scanning devices 212, 214 are mounted on a centerline of the APM head 210 on top of the cabin 213 (e.g., leftmost side edge of the cabin 213). LiDAR scanning device 212 has a view of the area behind the autonomous vehicle 200. The mounting and positioning of the one or more LiDAR scanning devices 212, 214, 216, 218 is described in more detail in FIG. 3. The one or more LiDAR scanning devices 212, 214, 216, 218 can perform scanning to collect data points associated with a container (e.g., container 120) placed on the APM trailer 220. At least some, if not all, collected data points (e.g., LiDAR points) are processed by the misalignment detection module 812 as described in detail in FIGS. 5-6.

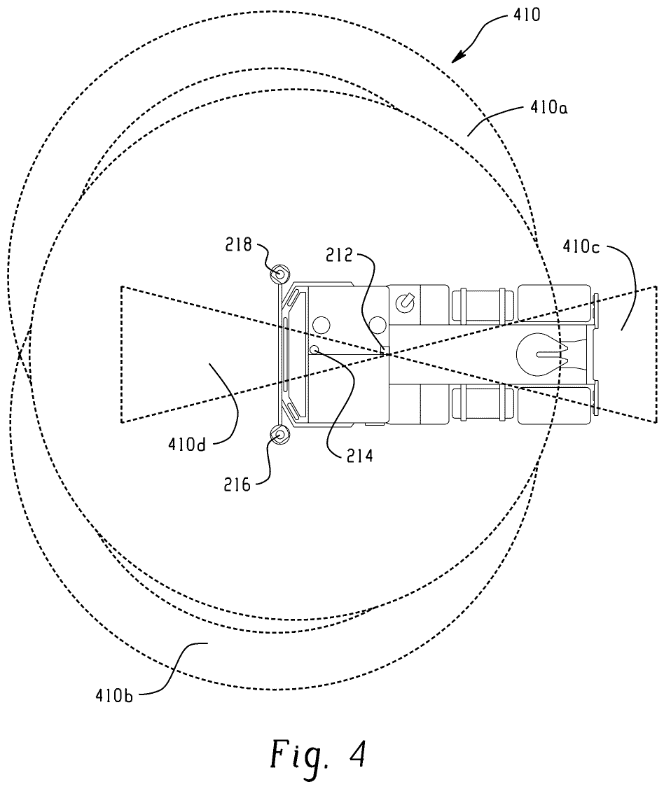

FIG. 3 is a diagram illustrating a side view of an example APM head 300 in accordance with various embodiments of the present disclosure. A LiDAR scanning device 310 (e.g., LiDAR scanning device 212 of FIGS. 2A-2B) is mounted on a surface 320 of the APM head 300 (e.g., cabin 213) via a mounting bracket 315. Mounting bracket 315 facilitates the positioning of a LiDAR scanning device 310 approximately perpendicular to the surface 320 of the APM head 300. LiDAR scanning devices 214, 216, 218 are oriented in a horizontal manner (e.g., parallel orientation). The perpendicular orientation of the LiDAR scanning device 310 coupled with multiple LiDAR scanning devices 310 (e.g., equivalent to LiDAR scanning device 212), 214, 216, 218 enables scanning of approximately 360-degrees surrounding the autonomous vehicle 200, to include container misalignment points 122, 124. More specifically, FIG. 4 is a diagram 400 illustrating a top view of multiple LiDAR scanning zones 410a, 410b, 410c, 410d that cumulatively form a 360-degree LiDAR scanning zone 410 of an example autonomous vehicle in accordance with various embodiments of the present disclosure. LiDAR scanning zone 410a is facilitated by the positioning of LiDAR device 218. LiDAR scanning zone 410b is facilitated by the positioning of LiDAR device 216. LiDAR scanning zone 410c is facilitated by LiDAR scanning device 212. LiDAR scanning zone 410d is facilitated by LiDAR scanning device 214. The LiDAR points detected within the 360-degree LiDAR scanning zone 410 (e.g., LiDAR scanning zones having visibility of the container 120 including LiDAR scanning zone 410a, 410b, and 410c) are processed by the container misalignment detection system 800 described in detail in FIG. 8.

FIG. 5 is a process flow diagram 500 illustrating a method of detecting container misalignment on an autonomous vehicle in accordance with various embodiments of the present disclosure. When a container 120 is loaded onto an APM trailer 220, the container misalignment detection system 800 can receive an indication that the container is loaded onto the autonomous vehicle from an external source in the form of data such as a user input into the container misalignment detection system 800 or an alert from a gantry crane used to place the container 120 onto the APM trailer 220. In order to detect container misalignment, LiDAR data is collected, at step 502. In some variations, this LiDAR data can be that collected from LiDAR scanning device 212, which is mounted on the rear of the cabin 213 closest to the container 210. As previously described in FIG. 4, LiDAR scanning device 212 can be used to detect points within LiDAR scanning zone 410c, including container 210. When loading of the container 120 onto the APM trailer 220 is complete, the LiDAR data points captured by LiDAR scanning device 212 that are located in the top area of the container front plane are evaluated, at step 504. The captured LiDAR data points are processed using the misalignment detection module 812 as described in FIG. 8. A maximum height of the LiDAR data points is determined in order to evaluate a height of the rooftop of the container 120, Z_MAX, at step 506. At step 508, the LiDAR data points near the rooftop container height are identified in order to obtain a maximum height of the leftmost point (e.g., container misalignment point 122 at the top front left corner of the container 120) and a maximum height of the rightmost point (e.g., container misalignment point 124 at the top front left corner of the container 120). The leftmost point and rightmost point are determined using the algorithm described in detail in FIG. 6. At step 510, the heights of the container misalignment points 122, 124 are evaluated to identify a height difference between the two. If the height difference between the container misalignment point 122 and the container misalignment point 124 is less than or equal to a height threshold (e.g., 0.05 m), the container 120 is aligned at step 512 (e.g., as shown in the example illustrated in FIG. 2B).

Alternatively, if the height difference between the container misalignment point 122 and the container misalignment point 124 is greater than a height threshold (e.g., 0.05 m), the container 120 is misaligned at step 514 (e.g., as shown in the example illustrated in FIG. 2A). If the container 120 is misaligned, corrective action can be taken such as repositioning the container 120 onto the APM trailer 220. In some variations, an alarm is triggered to facilitate human-aided manual re-loading or unloading of a container 120 onto the autonomous vehicle 200. Once the container 120 is re-aligned, the container misalignment system 800 can be used to re-evaluate the placement of the container 120.

FIG. 6 is a process flow diagram 600 illustrating additional steps performed by the misalignment detection module 812 of autonomous vehicle 200 in accordance with various embodiments of the present disclosure. For ease of understanding and illustration purposes only, FIG. 6 is discussed with reference to the shipping industry example. However, it can be appreciated by those of ordinary skill in the art that such example can be applicable to any industry or scenario where containers are loaded onto an autonomous vehicle.

Once LiDAR data is collected, at step 502, and a height of the rooftop of the container 120, Z_MAX, is determined at step 506, the leftmost point (e.g., container misalignment point 122 at the top front left corner of the container 120) and the rightmost point (e.g., container misalignment point 124 at the top front left corner of the container 120) are identified by the misalignment detection module 812. More specifically, as previously noted in FIG. 1A, the container misalignment points 122, 124 are located in a designated region 130. In a shipping industry application, for example, that designated region 130 is a three-dimensional (3D) region with an origin defined as the upright coordinate at the center of the rear axle footprint (e.g., projected onto the ground). The designated region 130 is defined in the x-axis between −0.2 m and 1.5 m. The x-axis is the central axis of the autonomous vehicle 200 pointing in the direction of APM head 210. The designated region 130 is defined in the y-axis between −1m and 1 m. The y-axis is the rear wheel axle of the autonomous vehicle 200. In the z-axis, the designated region 130 is defined by (i) the height of the container 120, Z_MAX, minus 0.15m and (ii) the height of the container 120, Z_MAX. As previously discussed, the height of the container 120, Z_MAX, is determined by step 506. The z-axis is defined to be zero at the ground and points upwards from ground.

With the defined designated region 130, at step 602, the misalignment detection module 812 identifies (e.g., searches) for candidate points within the LiDAR data that are located within designated region 130. These candidate points are considered “valid” for the purposes of identifying the container misalignment points 122, 124. From these candidate points, the misalignment detection module 812, at step 604, identifies the leftmost point as the container misalignment point 122 and the rightmost point as the container misalignment point 124.

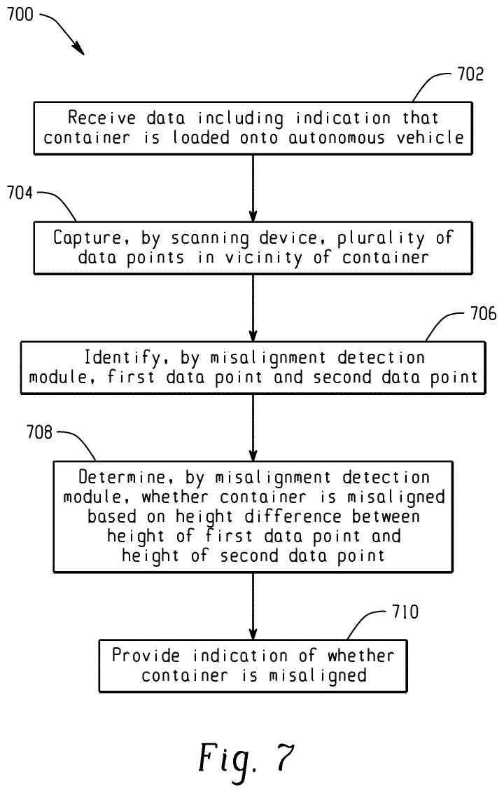

FIG. 7 is a process flow diagram 700 illustrating a method for detecting misalignment of a container loaded onto an autonomous vehicle in accordance with various embodiments of the present disclosure. At step 702, data including an indication that the container is loaded onto the autonomous vehicle is received. A scanning device (e.g., LiDAR scanning device 212) mounted on the autonomous vehicle 200 (e.g., mounted on cabin 213) captures a plurality of data points in the vicinity of the container at step 704. A misalignment detection module 812 identifies, at step 706, a first data point of the plurality of data points (e.g., container misalignment point 122) and a second data point of the plurality of data points (e.g., container misalignment point 124). the misalignment detection module 812 determines, at 708, whether the container is misaligned on the autonomous vehicle based on a height difference between a height of the first data point (e.g., container misalignment point 122) and a height of the second data point (e.g., container misalignment point 124). An indication of whether the container is misaligned is provided at step 710.

FIG. 8 illustrates an example container misalignment detection system 800 that processes input data 820 and generates output data 830 in accordance with various embodiments of the present disclosure. The input data 820 can be, for example, the LiDAR data points generated by the LiDAR scanning device 212 or an indication received via user input or from a gantry crane indicating that the container 120 is loaded onto the APM trailer 220. The container misalignment detection system 800 includes one or more processing systems 810. Processing system 810 includes a misalignment detection module 812, and data storage component 814. The input data 820 may be received by the processing system 810 via a communications network, e.g., an Internet, an intranet, an extranet, a local area network (“LAN”), a wide area network (“WAN”), a metropolitan area network (“MAN”), a virtual local area network (“VLAN”), and/or any other network. The input data 820 may also be received via a wireless, a wired, and/or any other type of connection. The input data 820 is processed by the misalignment detection module 812 utilizing the algorithms described in detail in FIGS. 5-6.

Processing system 810 may be implemented using software, hardware and/or any combination of both. Processing system 810 may also be implemented in a personal computer, a laptop, a server, a mobile telephone, a smartphone, a tablet, cloud, and/or any other type of device and/or any combination of devices. The misalignment detection module 812 may perform execution, compilation, and/or any other functions on the input data 820 as discussed in detail in FIGS. 5-6.

The data storage component 814 may be used for storage of data processed by processing system 810 and may include any type of memory (e.g., a temporary memory, a permanent memory, and/or the like).

Output data 830 can include any data generated by the misalignment detection module 812 such as an indication that a corner of a container cannot be found and the like. Output data 830 can also include any data stored within data storage component 814.

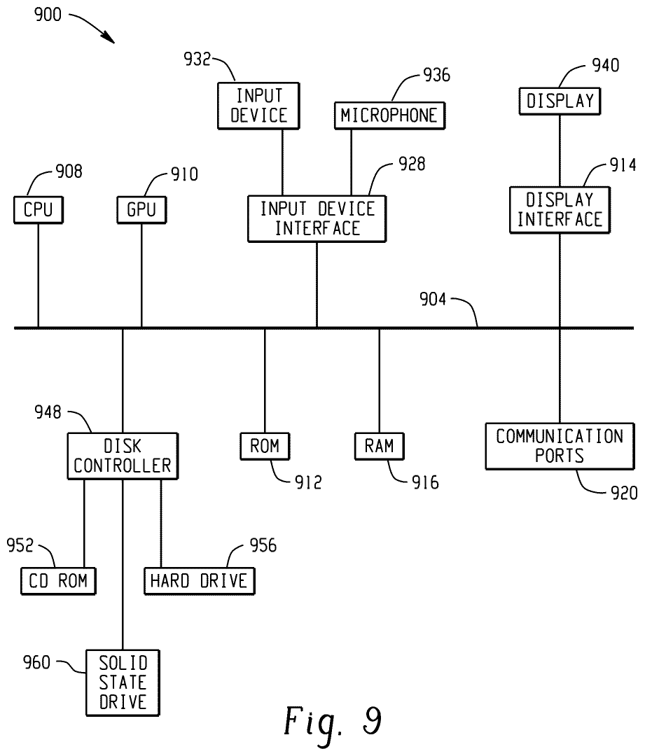

FIG. 9 is a diagram 900 illustrating a sample computing device architecture for implementing various aspects described herein in which certain components can be omitted depending on the application. A bus 904 can serve as the information highway interconnecting the other illustrated components of the hardware. A processing system 908 labeled CPU (central processing unit) (e.g., one or more computer processors/data processors at a given computer or at multiple computers) and/or a GPU-based processing system 910 can perform calculations and logic operations required to execute a program. A non-transitory processor-readable storage medium, such as read only memory (ROM) 912 and random access memory (RAM) 916, can be in communication with the processing system 908 and can include one or more programming instructions for the operations specified here. Optionally, program instructions can be stored on a non-transitory computer-readable storage medium such as a magnetic disk, optical disk, recordable memory device, flash memory, or other physical storage medium.

In one example, a disk controller 948 can interface with one or more optional disk drives to the system bus 904. These disk drives can be external or internal floppy disk drives such as 960, external or internal CD-ROM, CD-R, CD-RW or DVD, or solid state drives such as 952, or external or internal hard drives 956. As indicated previously, these various disk drives 952, 956, 960 and disk controllers are optional devices. The system bus 904 can also include at least one communication port 920 to allow for communication with external devices either physically connected to the computing system or available externally through a wired or wireless network. In some cases, the at least one communication port 920 includes or otherwise comprises a network interface.

To provide for interaction with a user, the subject matter described herein can be implemented on a computing device having a display device 940 (e.g., a CRT (cathode ray tube) or LCD (liquid crystal display) monitor) for displaying information obtained from the bus 904 via a display interface 914 to the user and an input device 932 such as keyboard and/or a pointing device (e.g., a mouse or a trackball) and/or a touchscreen by which the user can provide input to the computer. Other kinds of input devices 932 can be used to provide for interaction with a user as well; for example, feedback provided to the user can be any form of sensory feedback (e.g., visual feedback, auditory feedback by way of a microphone 936, or tactile feedback); and input from the user can be received in any form, including acoustic, speech, or tactile input. The input device 932 and the microphone 936 can be coupled to and convey information via the bus 904 by way of an input device interface 928. Other computing devices, such as dedicated servers, can omit one or more of the display 940 and display interface 914, the input device 932, the microphone 936, and input device interface 928.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

In the descriptions above and in the examples, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the examples is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A method for detecting misalignment of a container loaded onto an autonomous vehicle, the method comprising:
receiving data comprising an indication that the container is loaded onto the autonomous vehicle;
capturing, by a scanning device mounted on the autonomous vehicle, a plurality of data points in the vicinity of the container;
identifying, by a misalignment detection module, a first data point of the plurality of data points and a second data point of the plurality of data points;
determining, by the misalignment detection module, whether the container is misaligned on the autonomous vehicle based on a height difference between a height of the first data point and a height of the second data point; and
providing an indication of whether the container is misaligned.

2. The method of claim 1, wherein the container is misaligned when the height difference is greater than a height difference threshold.

3. The method of claim 1, wherein the first data point is located on a top front left corner of the container and the second data point is located on a top front right corner of the container.

4. The method of claim 1, further comprising identifying, using a misalignment detection module, heights associated with each of the plurality of data points; and identifying a maximum height of the plurality of data points that defines a rooftop of the container.

5. The method of claim 1, wherein the plurality of data points comprises a plurality of light and detection ranging (LiDAR) data points.

6. The method of claim 4, wherein the first data point and the second data point are identified from a subset of the plurality of datapoints located within a designated three-dimensional region surrounding the container.

7. The method of claim 6, wherein the first data point and the second data point are further identified from the subset based on a height that is greater than the maximum height minus an error correction value.

8. The method of claim 1, wherein the autonomous vehicle comprises a head and a trailer for loading of the container, and the scanning device is a light and detection ranging (LiDAR) scanning device mounted on a center line of the head.

9. The method of claim 8, wherein the LiDAR scanning device is mounted perpendicular to a top of the head of the autonomous vehicle.

10. The method of claim 1, wherein the autonomous vehicle is an autonomous prime mover.

11. The method of claim 1, wherein the container is automatically loaded or unloaded onto the autonomous vehicle without manual intervention by a gantry crane, and the indication is provided by either the gantry crane or user input.

12. The method of claim 1, wherein when the container is misaligned, an alarm is triggered to facilitate human-aided manual re-loading or unloading of the container onto the autonomous vehicle.

13. A system for detecting misalignment of a container loaded onto an autonomous vehicle, the system comprising:
at least one data processor; and
memory storing instructions, which when executed by at least one data processor, result in operations for implementing operations comprising:
receiving data comprising an indication that the container is loaded onto the autonomous vehicle;
capturing, by a scanning device mounted on the autonomous vehicle, a plurality of data points in the vicinity of the container;
identifying, by a misalignment detection module, a first data point of the plurality of data points and a second data point of the plurality of data points;
determining, by the misalignment detection module, whether the container is misaligned on the autonomous vehicle based on a height difference between a height of the first data point and a height of the second data point; and
providing an indication of whether the container is misaligned.

14. The system of claim 13, wherein the container is misaligned when the height difference is greater than a height difference threshold.

15. The system of claim 13, wherein the first data point is located on a top front left corner of the container and the second data point is located on a top front right corner of the container.

16. The systems of claim 13, wherein the operations further comprise identifying, using a misalignment detection module, heights associated with each of the plurality of data points; and identifying a maximum height of the plurality of data points that defines a rooftop of the container.

17. The system of claim 16, wherein the first data point and the second data point are identified from a subset of the plurality of datapoints located within a designated three-dimensional region surrounding the container based on a height that is greater than the maximum height minus an error correction value.

18. The system of claim 13, wherein the autonomous vehicle comprises a head and a trailer for loading of the container, and the scanning device is a light and detection ranging (LiDAR) scanning device mounted on a center line of the head, and wherein the LiDAR scanning device is mounted perpendicular to a top of the head of the autonomous vehicle.

19. The system of claim 13, wherein the autonomous vehicle is an autonomous prime mover.

20. A non-transitory computer program product storing instructions which, when executed by at least one data processor forming part of at least one computing device, implement operations comprising:
receiving data comprising an indication that the container is loaded onto the autonomous vehicle;
capturing, by a scanning device mounted on the autonomous vehicle, a plurality of data points in the vicinity of the container;
identifying, by a misalignment detection module, a first data point of the plurality of data points and a second data point of the plurality of data points;
determining, by the misalignment detection module, whether the container is misaligned on the autonomous vehicle based on a height difference between a height of the first data point and a height of the second data point; and
providing an indication of whether the container is misaligned.
